(19) United States
(12) Patent Application Publication
(10) Pub. No.: US 2016/0116656 A1
(43) Pub. Date: Apr. 28, 2016

(54) LARGE BANDWIDTH VOLUME HOLOGRAPHIC PHASE CONVERTER APPARATUS, METHODS, AND APPLICATIONS

(71) Applicant: UNIVERSITY OF CENTRAL FLORIDA, Orlando, FL (US)

(72) Inventors: Leonid Glebov, Orlando, FL (US); Ivan Divliansky, Orlando, FL (US); Marc SeGall, San Pedro, CA (US)

(73) Assignee: UNIVERSITY OF CENTRAL FLORIDA, Orlando, FL (US)

(21) Appl. No.: 14/521,852

(22) Filed: Oct. 23, 2014

(51) Int. Cl. G02B 5/32; G03H 1/04; G03H 1/02

(52) U.S. Cl. CPC G02B 5/32; G03H 1/0248; G03H 1/0402; G03H 2001/026; G03H 2001/0439

(57) ABSTRACT

A volume Bragg grating (VBG) containing one or more controlled phase profiles holographically embedded therein that is operable over a broad wavelength range, methods for making such controlled phase profile-embedded VBGs, and applications thereof.

This application claims priority to U.S. provisional application 61/894,470 filed Oct. 23, 2013, the subject matter of which is incorporated herein by reference in its entirety.

### GOVERNMENT FUNDING

This research was supported by HEL JTO (ARO contract # W911NF1010441). The U.S. Government has certain rights in the invention.

### BACKGROUND

Aspects and embodiments of the invention are generally in the field of volume holographic elements and their methods for fabrication. More particularly, aspects and embodiments of the invention relate to a volume Bragg grating (VBG) containing one or more controlled phase profiles holographically embedded therein that is operable over a broad wavelength range, methods for making such controlled phase profile-embedded VBGs, and applications thereof.

Volume Bragg gratings (VBGs) are diffractive optical elements fabricated in the volume of a thick, transparent optical material, which possess periodical variation of refractive index in one direction. A VBG provides diffraction of an incident optical beam if it has the proper wavelength and is launched at the proper angle of incidence, known as the Bragg condition. An ideal VBG has a uniform average refractive index and a uniform spatial refractive index modulation. These features enable fine spectral and angular selection when diffracted beams have no induced phase distortions. Such VBGs are usually recorded in photosensitive media by exposing them to an interference pattern produced by coherent collimated beams with uniform spatial distribution of intensity and phase. One important characteristic of VBGs is the ability to multiplex multiple elements in the same volume of a photosensitive medium, which enables mux/demux operations for optical communications along with spectral and coherent beam combining.

To provide the necessary phase transformations in optical beams, for example, for mode conversion, coupling to complex optical components with spatial phase modulation is required. These components may be phase masks, spatial light modulators, deformable minors, and others well known in the art. The general feature of all phase transformers is an ability to work at a specified wavelength because the phase shift is uniquely determined by a product of refractive index and thickness. Moreover, any phase mask can provide only a single phase pattern.

Conventional surface phase masks have been developed over the past several decades to produce a controlled phase profile for an optical system. In order to create the local phase profile the local optical path length is controlled, whether by controlling the geometrical path length or the local refractive index. They have been recorded using a wide variety of substrates with different methods of surface profiling by means of etching or deposition along with surface refractive index change in such media as photoresist and dichromated gelatin. However, in each case the principle behind the element is the same; because the optical path length is controlled, the phase profile is designed for a specific wavelength corresponding to that optical path length difference. This inherently limits conventional phase masks to uses in monochromatic systems. Some extension of spectral region for phase transformers is possible with the use of substrates made of birefringent media or birefringence in surface diffractive gratings included in phase transforming devices.

A new type of volume phase mask has been reported where a spatial profile of refractive index in the bulk of a phase photosensitive media (e.g., photo-thermo-refractive (PTR) glass) is created by illumination with an optical beam with a specified spatial profile of dosage. This type of volume phase mask may be referred to as an ‘original’ volume phase mask, where the desired phase profile is represented in the transmitted beam. These ‘original’ volume phase masks provide the same beam transformation in the optical far field as conventional surface phase masks and are advantageous because of polished surfaces with no complex profile, which enable higher reliability in harsh environmental conditions. For closed systems that are not intended to be significantly modified, this is sufficient. However, if the system is intended to have multiple configurations and/or outputs, it is necessary to have multiple masks with each mask designed to the needs of the current system requirements. While multiple masks can be designed and then swapped in/out as needed, this is an inefficient method, requiring realignment and potentially requiring the same material properties such as physical thickness and losses.

‘Thin film’ holographic phase masks have also been demonstrated in the literature, where the probe wavelength is required to be the same as the recording wavelength.

The inventors have thus recognized the benefits and advantages of recording not an ‘original’ volume phase mask as described hereinabove, but rather a ‘hologram’ of a desired phase mask, wherein a controlled phase profile is embedded in a volume Bragg grating recorded in a single, thick (i.e., on the order of several mm) piece of a volume phase photosensitive medium (e.g., PTR glass), as opposed to a thin media (i.e., on the order of tens of microns) in the same manner in which the volume Bragg grating is holographically recorded in the bulk volume phase photosensitive medium. This phase profile hologram provides operation over an extremely large bandwidth that covers the transparency spectrum of the medium, which for photo-thermo-refractive (PTR) glass, for example, goes from 350 nm to 2700 nm. Moreover, multiple phase profiles can be holographically recorded in the same single piece of bulk volume phase photosensitive medium utilizing the established techniques of multiplexing volume Bragg gratings to multiplex each holographic phase mask. The embodied apparatus and method thus enable the combination of the phase transformation properties of one or more phase masks with the properties of volume Bragg gratings into a single bulk element, operable at different wavelengths over a large bandwidth extending from 350-2700 nm.

For simplicity of discussion, the embodied structure will be referred to hereinafter as a ‘volume holographic phase mask.’

### SUMMARY

An aspect of the invention is a volume holographic phase mask. According to an exemplary embodiment, a volume holographic phase mask includes a single, bulk piece of a volume phase photosensitive medium, having a spatial pattern of refractive index corresponding to a spatial pattern of applied actinic optical radiation, containing within a volume of the bulk piece of the phase photosensitive medium at least one volume holographic Bragg grating with at least one embedded spatial phase pattern. In various non-limiting aspects, the volume holographic phase mask may further include or be further characterized by the following features or limitations:
wherein the single, bulk piece of volume phase photosensitive medium is photo-thermo-refractive (PTR) glass;
further comprising at least a second, different volume holographic Bragg grating with at least a second, embedded different phase profile;
wherein the phase profile is a binary phase profile;
characterized by a multiwavelength operating bandwidth corresponding to any wavelength that can satisfy the Bragg condition for a recorded VBG.

An aspect of the invention is a method for making a volume holographic phase mask. According to an exemplary embodiment, the method includes recording a volume holographic Bragg grating in a single, bulk piece of volume phase photosensitive medium using a two beam holographic optical setup where at least one known phase pattern generating object is disposed in at least one beam of the two beam holographic optical setup. In various non-limiting aspects, the method may further include or be further characterized by the following features or limitations:
further comprising replacing the at least one known phase pattern generating object in the at least one beam with a second, different known phase pattern generating object; and changing an incident angle of a recording beam illuminating the single, bulk piece of the volume phase photosensitive medium and recording a second volume hologram of the different known phase pattern in the single, bulk piece of the volume phase photosensitive medium.

An aspect of the invention is a method for multiplexing and/or demultiplexing of optical beams using a volume holographic phase mask. According to an exemplary embodiment, the method includes inputting to a volume holographic phase mask comprising a single, bulk piece of volume phase photosensitive medium containing within a volume of the bulk piece of volume phase photosensitive medium at least two permanent volume holographic Bragg gratings (VBGs) with at least two permanent corresponding holographic phase profiles, at least a first beam having a wavelength λ₁ satisfying the Bragg condition for the first recorded VBG and at least a second beam having a wavelength λ₂ satisfying the Bragg condition for the second recorded VBG; and outputting a single beam comprising λ₁ and λ₂ having different phase profiles, or inputting a single beam comprising λ₁ and λ₂ with different phase profiles to a volume holographic phase mask comprising a single, bulk piece of volume phase photosensitive medium containing within a volume of the bulk piece of volume phase photosensitive medium at least two permanent volume holographic Bragg gratings (VBGs) with at least two permanent corresponding holographic phase profiles, at least a first beam having a wavelength λ₁ satisfying the Bragg condition for the first recorded VBG and at least a second beam having a wavelength λ₂ satisfying the Bragg condition for the second recorded VBG; and outputting two beams with wavelengths λ₁ and λ₂ with different phase profiles. In various non-limiting aspects, the method may further include or be further characterized by the following features or limitations:
wherein the first input beam has a first mode and the second input beam has a second, different mode, and the single output beam has a desired mode that may or may not be selected to be the first mode or the second mode.

### BRIEF DESCRIPTION OF THE FIGURES

FIG. 1 schematically illustrates a two beam holographic optical setup for creating a volume holographic phase mask in a single, thick sample of PTR glass, according to an embodiment of the invention.

FIG. 2 shows a diffracted Gaussian beam after passing through a volume holographic phase mask encoded with a four-sector mode converter as depicted in FIG. 1 at: (a) 7 cm after the mask, (b) 20 cm after the mask, and (c) in the optical far field at the focal plane of a lens, according to an illustrative embodiment of the invention.

FIG. 3 shows photos of a Gaussian beam (top) and diffracted beams converted to TEM-11 mode at 633 nm, 975 nm and 1064 nm by a single volume holographic phase mask, according to a demonstrative embodiment of the invention.

FIG. 4 illustrates operation of a multiplexed volume holographic phase mask where, depending on the incident angle of a Gaussian beam, a diffracted beam would be Gaussian TEM-00 TEM-01, or TEM-11, according to a demonstrative embodiment of the invention.

FIG. 5 illustrates a volume holographic phase mask for simultaneous beam multiplexing (combining) and mode conversion if illuminated from the left side, or beam demultiplexing (analyzing) and mode conversion if illuminated from the right side, according to an illustrative embodiment of the invention.

FIG. 6 is an example of complex optical beam transformations that could be produced by multiplexed volume holographic phase masks, in which two Gaussian beams are converted to TEM-11 beams by a single volume holographic phase mask and then combined into a single Gaussian beam, according to an illustrative embodiment of the invention.

### DETAILED DESCRIPTION OF NON-LIMITING, EXEMPLARY EMBODIMENTS OF THE INVENTION

The embodied method is based on a holographic recording of a phase mask in a volume phase photosensitive medium. For the sake of discussion, we disclose recording one of trivial holograms, notably, a transmitting volume Bragg grating, which is a system of plain layers with modified refractive index, where an incident beam crosses the front surface of the volume phase photosensitive medium while a diffracted beam crosses the back surface of the holographic element. However, more complex holograms could be used for the incorporation of phase masks.

Furthermore, the term ‘volume phase photosensitive medium’ as used herein is one demonstrating a permanent refractive index change after exposure to actinic optical radiation, as opposed to what may be referred to in the art as a ‘dynamic’ medium. The embodied volume phase photosensitive media include commercially available media such as but not limited to, e.g., iron doped lithium niobate, dichromated gelatin, several photopolymers, and photo-thermo-refractive glass. Moreover, materials such as chalcogenide glass, Eu-doped silicate glass, etc. were used to demonstrate volume phase hologram recording. Hereinafter, we will refer to photo-thermo-refractive (PTR) glass to simplify discussion and because it advantageously enables fabrication of high quality volume holographic elements. However, other phase volume photosensitive materials as referred to above could be used for volume holographic phase mask recording.

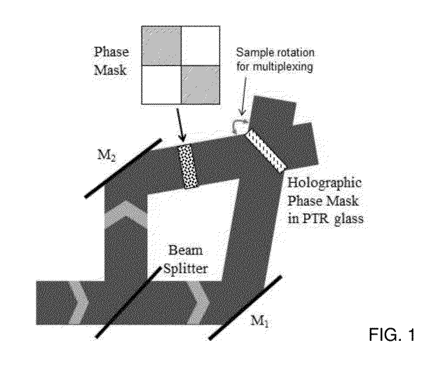

A method of fabrication of a volume holographic phase mask involves recording a phase mask hologram in a single, bulk piece of PTR glass by interference of coherent collimated beams with specified phase profiles, as illustrated in FIG. 1. The method enables the combination of the phase transformation properties of a phase mask with the properties of a volume Bragg grating into a single, bulk piece of PTR glass and provides operation at any wavelength that satisfies the Bragg condition for the recorded VBG. Moreover, the embodied method enables recording of several VBGs with imbedded phase masks in the same volume of photosensitive material. This is accomplished by creating single or multiplexed holograms of the desired transforming phase mask profiles.

Operationally, a surface or volume phase mask is first created using any of the known techniques (e.g., lithography followed by etching or deposition, spatial light modulators, contact copying via amplitude masks, recording in volume of a photosensitive medium, etc.) such that the desired phase profile is achieved for the hologram recording wavelength. This phase mask is then placed in one of the collimated recording beams of a two-beam holographic setup (FIG. 1) typically used for fabrication of volume Bragg gratings. Thus, a hologram of the phase profile is imbedded in the recorded VBG. When a beam at the recording wavelength with a plain wavefront is incident at the Bragg angle, the diffracted beam will bear the phase pattern contained in the phase mask and, therefore, be converted to the desired mode in the same manner as an original phase mask would convert a beam.

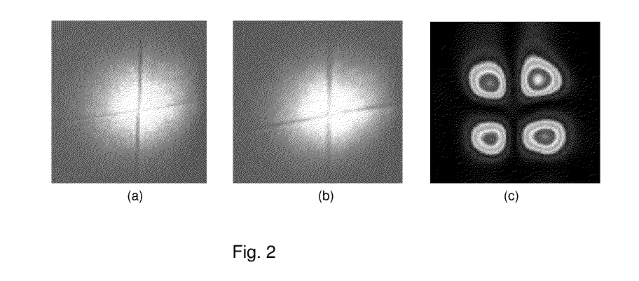

FIG. 2 illustrates that a Gaussian beam diffracted by a four sector holographic phase mask has almost the original profile in the optical near field (2a, 2b) but it is converted to a TEM-11 mode in the far field (2c). Thus, a volume holographic phase mask provides the same beam transformation as an original phase mask.

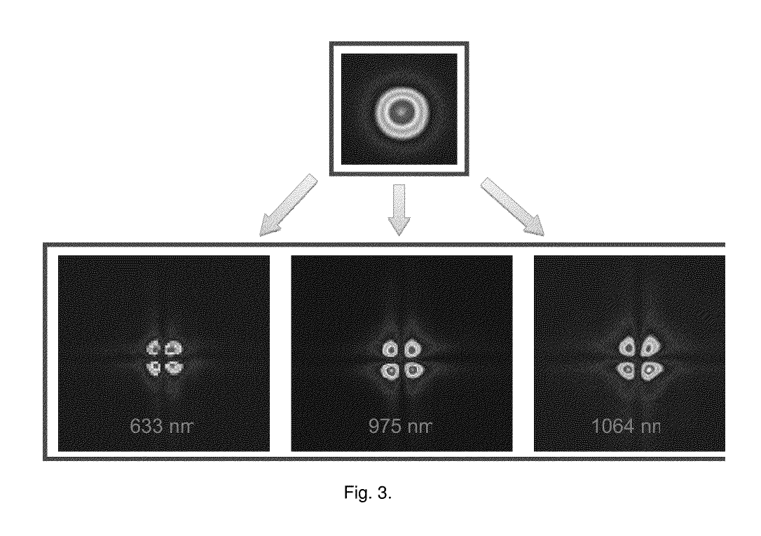

The spectral range of applications of holograms goes beyond the spectral region of photosensitivity. In the instant case, a significant peculiarity of such a volume holographic phase mask recorded in a VBG is that it works for a wide range of wavelengths. It is well known that holograms in general possess high chromatism and can be reconstructed only at the same wavelength that was used for recording. However, it is an inherent property of uniform VBGs that by proper choice of incident angle, diffraction can be obtained for different wavelengths. This effect is provided by changing incident angles to satisfy the Bragg condition for different wavelengths. This VBG inclination automatically provides changing of phase incursion for a propagating beam and, therefore, keeps the phase profile in the diffracted beam constant for any wavelength. This is why, contrary to conventional phase masks, volume holographic phase masks imbedded in VBGs can operate at any wavelength that can satisfy the Bragg condition for a recorded VBG. FIG. 3 shows that diffraction of a Gaussian beam by a four-sector holographic phase mask results in conversion to TEM-11 mode for different wavelengths in the visible to the IR spectral region.

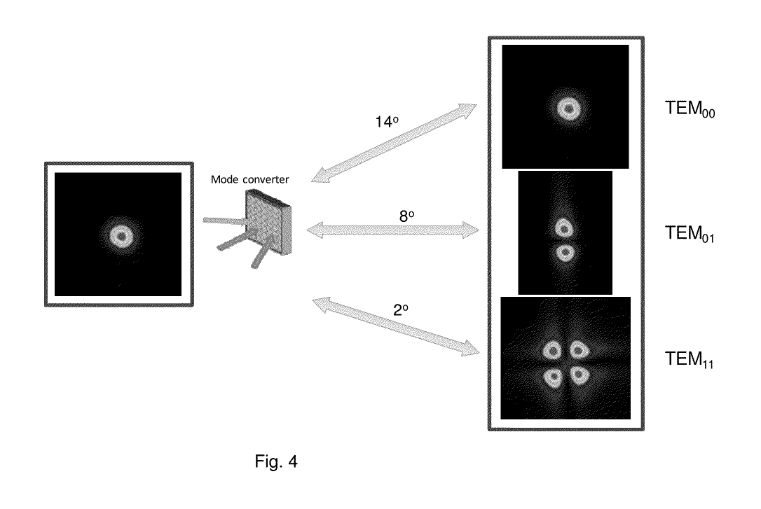

Multiplexing of phase masks is achieved by performing sequential recordings of different VBGs where for each recording the grating period is changed or the PTR recording medium is rotated and the same or a different phase mask is placed in the recording arm. Each phase mask would work at a particular wavelength only if the VBG is illuminated at the corresponding incident angle to provide diffraction. It is possible to record multiple VBGs with degenerate Bragg angles when several VBGs have a common Bragg angle. In this case, different beams incident at the different Bragg angles will diffract from these multiplexed gratings such that they propagate collinearly from a common point, allowing for beam combining as illustrated in FIG. 4. In this case, different beam transformers could be multiplexed, e.g., to provide conversion of several different modes in a single optical beam.

In the embodiments described herein, the holograms are recorded in a thick, bulk piece of PTR glass, so any wavelength satisfying the Bragg condition, regardless of whether or not it is the recording wavelength, will diffract and have the same phase profile. Based on the transparency window of PTR glass, this provides a useful wavelength range from 325 nm to beyond 2 μm, vastly surpassing the monochromatic nature of traditional phase masks and spatial light modulators.

PTR glass is a sodium-potassium-zinc-aluminum-fluorine-bromine-silicate glass doped with cerium, antimony, tin, and silver, with a region of transparency from 350 nm to 2700 nm and a damage threshold of 40 J/cm². Due to this wide transparency window, PTR glass is used to produce volume Bragg gratings for the visible and infrared regions, which have found applications in pulse stretching and compression, beam combining, and ultra-narrow spectral filtering. In the near IR region, PTR glass has an absorption coefficient of ˜10⁻⁴/cm, which, coupled with its glass transition temperature of ˜460° C., makes a suitable substrate for high power and high temperature systems. In addition, forced air cooling can be applied to the sample without degrading the recorded profile or seriously affecting the transmitted beam.

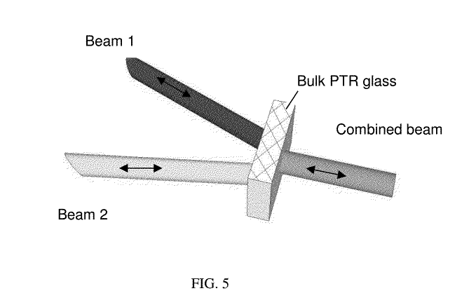

The feasibility of multiplexing holographic phase masks in the same volume of PTR glass enables unique opportunities for multiplexing and demultiplexing optical beams with different wavelengths and modes of propagation. FIG. 5 shows that if two different VBGs are recorded in such manner that they have collinear one of the Bragg angles, this device would be a multiplexer or a beam combiner if illuminated by two beams approaching the VBG from the left side. The diffracted beams would be overlapped in both near and far fields. If these VBGs have imbedded phase masks, this device has two simultaneous functions—multiplexing and mode conversion. This device illuminated from the right side would operate as demultiplexer or a beam analyzer that simultaneously can produce mode conversion.

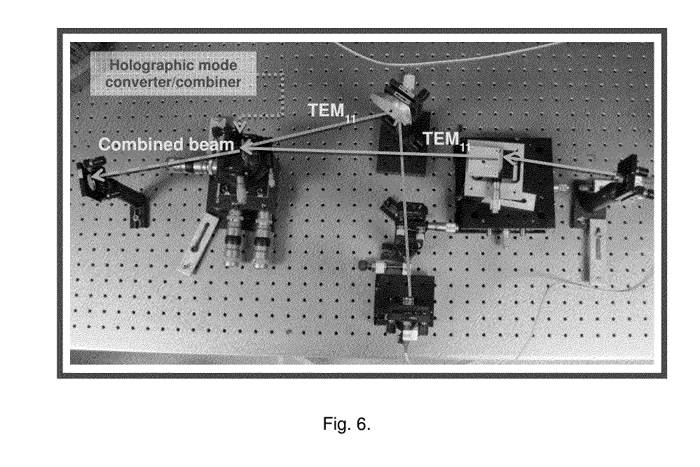

It is clear that combination of different single and multiplexed holographic phase masks can provide a wide variety of optical beam transformations that could be useful for optical processing or high power laser design. FIG. 6 is a photo of an experimental setup where two Gaussian beams are converted to TEM-11 beams by a single volume holographic phase mask. After propagation for a distance, these beams are simultaneously converted to Gaussian beams and combined in the near and far fields (in space and angles). It is clear that similar procedures could be demonstrated with different binary and grey scale holographic phase masks that could be fabricated with different levels of multiplication.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

We claim:

1. A volume holographic phase mask, comprising:
a single, bulk piece of a volume phase photosensitive medium, having a spatial pattern of refractive index corresponding to a spatial pattern of applied actinic optical radiation, containing within a volume of the bulk piece of the phase photosensitive medium at least one volume holographic Bragg grating with at least one embedded spatial phase pattern.

2. The volume holographic phase mask of claim 1, wherein the single, bulk piece of volume phase photosensitive medium is photo-thermo-refractive (PTR) glass.

3. The volume holographic phase mask of claim 1, further comprising:
at least a second, different volume holographic Bragg grating with at least a second, embedded different phase profile.

4. The volume holographic phase mask of claim 1, wherein the phase profile is a binary phase profile.

5. The volume holographic phase mask of claim 1, characterized by a multiwavelength operating bandwidth corresponding to any wavelength that can satisfy the Bragg condition for a recorded VBG.

6. A method for making a volume holographic phase mask, comprising:
recording a volume holographic Bragg grating in a single, bulk piece of volume phase photosensitive medium using a two beam holographic optical setup where at least one known phase pattern generating object is disposed in at least one beam of the two beam holographic optical setup.

7. The method of claim 6, further comprising:
replacing the at least one known phase pattern generating object in the at least one beam with a second, different known phase pattern generating object; and
changing an incident angle of a recording beam illuminating the single, bulk piece of the volume phase photosensitive medium and recording a second volume hologram of the different known phase pattern in the single, bulk piece of the volume phase photosensitive medium.

8. A method for multiplexing and/or demultiplexing of optical beams using a volume holographic phase mask, comprising:
inputting to a volume holographic phase mask comprising a single, bulk piece of volume phase photosensitive medium containing within a volume of the bulk piece of volume phase photosensitive medium at least two permanent volume holographic Bragg gratings (VBGs) with at least two permanent corresponding holographic phase profiles, at least a first beam having a wavelength λ₁ satisfying the Bragg condition for the first recorded VBG and at least a second beam having a wavelength λ₂ satisfying the Bragg condition for the second recorded VBG; and
outputting a single beam comprising λ₁ and λ₂ having different phase profiles, or
inputting a single beam comprising λ₁ and λ₂ with different phase profiles to a volume holographic phase mask comprising a single, bulk piece of volume phase photosensitive medium containing within a volume of the bulk piece of volume phase photosensitive medium at least two permanent volume holographic Bragg gratings (VBGs) with at least two permanent corresponding holographic phase profiles, at least a first beam having a wavelength λ₁ satisfying the Bragg condition for the first recorded VBG and at least a second beam having a wavelength λ₂ satisfying the Bragg condition for the second recorded VBG; and
outputting two beams with wavelengths λ₁ and λ₂ with different phase profiles.

9. The method of claim 8, wherein the first input beam has a first mode and the second input beam has a second, different mode, and the single output beam has a desired mode that may or may not be selected to be the first mode or the second mode.
